(19) United States
(12) Patent Application Publication
(10) Pub. No.: US 2014/0098360 A1
(43) Pub. Date: Apr. 10, 2014

(54) METHOD OF DISCRIMINATING BANKNOTE USING TERAHERTZ ELECTROMAGNETIC WAVES

(71) Applicant: Jina KWON, Seoul (KR)

(72) Inventor: Jina KWON, Seoul (KR)

(73) Assignee: KISAN ELECTRONICS CO., LTD., Seoul (KR)

(21) Appl. No.: 14/039,460

(22) Filed: Sep. 27, 2013

(30) Foreign Application Priority Data
Oct. 4, 2012 (KR) 10-2012-0110340
Oct. 4, 2012 (KR) 10-2012-0110342

(51) Int. Cl. G06K 9/00

(52) U.S. Cl. CPC G06K 9/00442
USPC 356/51

(57) ABSTRACT

A method of discriminating a banknote using terahertz waves includes irradiating a banknote with terahertz waves; detecting reflected waves reflected from the banknote; generating a reflected image of the banknote based on the detected reflected waves; and discriminating the banknote based on the reflected image. Accordingly, whether a banknote is genuine or counterfeit, and the denomination of the banknote, may be easily and correctly determined using the reflected waves or transmitted waves passing through the banknote.

### CROSS-REFERENCE TO RELATED APPLICATION

The present application claims the benefits of priorities of Korean Patent Application Nos. 10-2012-0110340 and 10-2012-0110342, filed with the Korean Intellectual Property Office on Oct. 4, 2012. The contents of these applications are incorporated herein by reference in their entireties.

### BACKGROUND OF THE INVENTION

1. Field of the Invention

The present invention relates to a method of discriminating a banknote using terahertz waves, and more particularly, to a method of discriminating a banknote using terahertz waves in which the banknote is irradiated with terahertz waves so that one can determine whether the banknote is genuine or counterfeit, and a denomination (or kind) of the banknote may be determined.

2. Description of the Related Art

In general, a banknote counter is an apparatus for counting banknotes. A conventional banknote counter simply has a function of counting banknotes. However, recently, banknote counters for determining whether a banknote is genuine or counterfeit and a denomination of the banknote are suggested.

For example, there are suggested a method of recognizing fragmentary characteristics of a banknote such as a size and a color of the banknote to recognize a denomination of the banknote, a method of scanning an image of a banknote to compare the scanned image with an image of a basic banknote to determine whether the banknote is genuine or counterfeit in accordance with similarity between the two images, or a method of using an infrared ray (IR) sensor, a magnetic sensor and a ultraviolet ray (UV) sensor to determine whether the banknote is genuine or counterfeit based on the respective sensed results.

However, when the denomination of the banknote is determined by the size and the color of the banknote or when it is determined whether the banknote is genuine or counterfeit using the whole surface image of the banknote, correctness of determination deteriorates.

On the other hand, terahertz (THz) electromagnetic waves in a region between 100 GHz and 10 THz can pass through non-metal and non-polar materials and have higher transmittance than IR. Such waves can be used for determining whether a banknote and a document are genuine or counterfeit so that a clearer image may be obtained and, although an image is contracted, transformation in the image is not caused by pixel changes. In addition, since resonance frequencies of various molecules are distributed in the terahertz frequency region, new analytical technologies are expected to be provided in various fields such as medicine, agriculture, food, environment measurement, biology, security, and high-tech material evaluation.

Since a signal of a terahertz (THz) band as very low energy of several meV hardly has any influence on a human body, it is rapidly emerging as an essential core technology of realizing a human centered ubiquitous society.

A related reference is Korean Patent Application Publication No. 10-2004-0068659 (published on Aug. 2, 2004).

### SUMMARY OF THE INVENTION

Accordingly, the present invention has been made in an effort to solve the above problems. It is an object of the present invention to provide a method of discriminating a banknote using terahertz waves in which the authenticity of a banknote (e.g., whether it is genuine or counterfeit) and/or a denomination of the banknote may be easily and correctly determined using reflected waves or transmitted waves generated by irradiating the banknote with the terahertz waves.

According to one aspect of the present invention, there is provided a method of discriminating a banknote using terahertz waves comprising irradiating the banknote with terahertz waves; detecting reflected waves reflected from the banknote; generating a reflected image of the banknote based on the detected reflected waves; and discriminating the banknote based on the reflected image.

According to another aspect of the present invention, there is provided a method of discriminating a banknote comprising irradiating the banknote with terahertz waves; detecting transmitted waves transmitted through the banknote; generating a transmitted image of the banknote based on the detected transmitted wave; and discriminating the banknote based on the transmitted image.

According to still another aspect of the present invention, there is provided a method of discriminating a banknote comprising irradiating the banknote with terahertz waves; detecting reflected waves reflected from the banknote; measuring an energy of the reflected waves; and discriminating the banknote based on the measured energy.

The method of discriminating the banknote using terahertz waves according to the present invention can easily and correctly determine whether the banknote is counterfeit or genuine, and can easily and correctly determine the denomination of the banknote, using the reflected waves and/or the transmitted waves generated by irradiating the terahertz waves on the banknote. The present invention allows identifying a counterfeit banknote without using an infrared ray (IR) sensor, a magnetic sensor and an ultraviolet ray (UV) sensor which have been used together with a conventional contact image sensor (CIS). Therefore, a structure of a banknote discriminating apparatus may be simplified and cost may be reduced.

### BRIEF DESCRIPTION OF THE DRAWINGS

FIG. 1 is a block diagram illustrating an example of a banknote discriminating apparatus using terahertz waves according to an embodiment of the present invention;

FIG. 2 is a view schematically illustrating structures of a terahertz wave irradiating unit, a reflected terahertz wave detecting unit and a transmitted terahertz wave detecting unit for describing a method of discriminating a banknote using terahertz waves according to an embodiment of the present invention;

FIG. 3 is a view schematically illustrating other structures of a terahertz wave irradiating unit, a reflected terahertz wave detecting unit, and a transmitted terahertz wave detecting unit for describing a method of discriminating a banknote using terahertz waves according to an embodiment of the present invention;

FIG. 4 is a flowchart illustrating a method of discriminating a banknote using a reflected image of a banknote obtained by terahertz waves according to an embodiment of the present invention;

FIG. 5 is a flowchart illustrating a method of discriminating a banknote using a transmitted image of a banknote obtained by terahertz waves according to an embodiment of the present invention;

FIG. 6 is a flowchart illustrating a method of discriminating a banknote using energy of reflected waves obtained by terahertz waves according to an embodiment of the present invention;

FIG. 7 is a view illustrating an image of a banknote generated using terahertz waves according to an embodiment of the present invention;

FIG. 8 illustrates reflectance of reflected wave energy of terahertz waves irradiated respectively onto a counterfeit banknote and a genuine banknote according to an embodiment of the present invention; and

FIG. 9 illustrates an example of a transmitted image of a banknote generated using terahertz waves according to an embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In the entire specification and claims, unless explicitly described to the contrary, the word such as “includes”, “including”, “comprises” or “comprising”, etc. will be understood to imply the inclusion of stated elements but not the exclusion of any other elements.

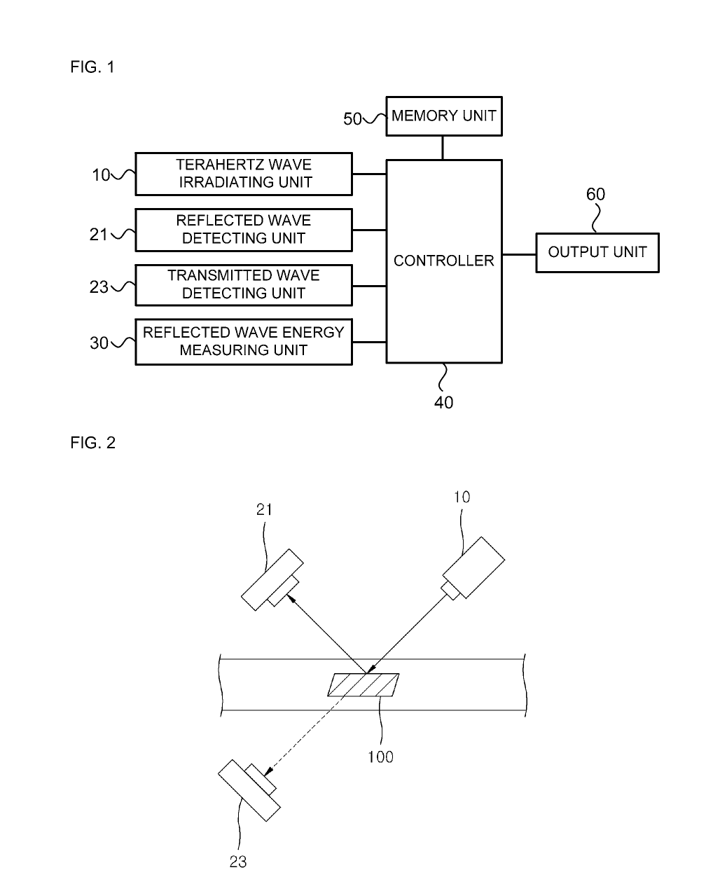

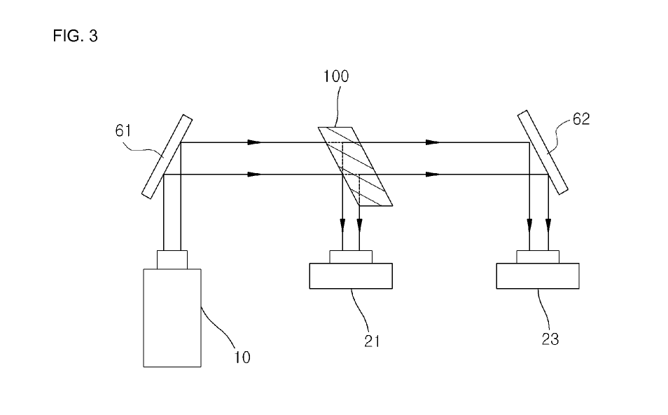

As illustrated in FIGS. 1 to 3, a banknote discriminating apparatus using terahertz waves according to the present embodiment includes a terahertz wave irradiating unit 10 for irradiating terahertz waves onto a banknote 100, a reflected wave detecting unit 21 for detecting reflected waves reflected from the banknote, a transmitted wave detecting unit 23 for detecting transmitted waves transmitted through the banknote, a reflected wave energy measuring unit 30 for measuring reflected wave energy of the reflected waves based on a detection signal detected by the reflected wave detecting unit 21, and a controller 40 for generating a reflected image of the banknote based on a detection signal detected by the reflected wave detecting unit 21, generating a transmitted image of the banknote based on a detection signal detected by the transmitted wave detecting unit 23, and determining whether the banknote is counterfeit or genuine and/or the denomination of the banknote using at least one of the reflected image, the transmitted image, and the reflected wave energy. On the other hand, as illustrated in FIG. 1, the banknote discriminating apparatus may include the reflected wave detecting unit 21, the transmitted wave detecting unit 23, and the reflected wave energy measuring unit 30, and may further include at least one or two of the reflected wave detecting unit 21, the transmitted wave detecting unit 23, and the reflected wave energy measuring unit 30 in accordance with an embodiment environment or selection of anyone skilled in the art.

In case of determining whether the banknote is counterfeit or genuine, the controller 40 may determine whether the banknote is counterfeit or genuine by at least one of comparing an average value of brightness values of respective pixels in a predetermined first interest region of the reflected image with a predetermined reference brightness value and determining whether a watermark image exists in a predetermined second interest region of the transmitted image.

In addition, the controller 40 may further determine whether the banknote is counterfeit or genuine based on the measured reflected wave energy. In particular, the controller 40 may determine the banknote as a counterfeit banknote when a reflectance of the reflected wave energy with respect to energy of the terahertz waves irradiated on the banknote is higher than a predetermined reference reflectance. Alternatively, the banknote may be determined to be counterfeit when a comparison of the reflectance of the measured energy with the energy of the terahertz waves, or a difference between the reflectance of the measured energy with the energy of the terahertz waves, is greater than a predetermined threshold value.

The banknote discriminating apparatus using terahertz waves according to the present embodiment may further include a first mirror 61 for focusing the terahertz waves irradiated by the terahertz wave irradiating unit 10 to irradiate the focused terahertz waves on the banknote 100 and a second mirror 62 for focusing the terahertz waves transmitted through the banknote 100 to input the focused terahertz waves to the transmitted wave detecting unit 23. That is, the terahertz waves irradiated by the terahertz wave irradiating unit 10 are irradiated on the banknote 100 by the first mirror 61 and the terahertz waves transmitted through the banknote 100 may be input to the transmitted wave detecting unit 23 by the second mirror 62.

The operation of the banknote discriminating apparatus structured as described above according to the present embodiment will be described in detail with reference to FIGS. 1 to 9.

The banknote discriminating apparatus using the terahertz waves according to the present embodiment may determine whether the banknote is counterfeit or genuine, or the denomination of the banknote, by irradiating the terahertz waves onto the banknote and using at least one of the reflected image of the banknote generated by the reflected waves reflected from the banknote, the transmitted image of the banknote generated by the transmitted waves transmitted through the banknote, the reflected wave energy of the reflected waves reflected from the banknote, and a combination of the reflected image of the banknote generated by the reflected waves reflected from the banknote, the transmitted image of the banknote generated by the transmitted waves transmitted through the banknote, and the reflected wave energy of the reflected waves reflected from the banknote. Hereinafter, the each banknote discriminating method will be described in detail.

Banknote Discriminating Method Using Reflected Image

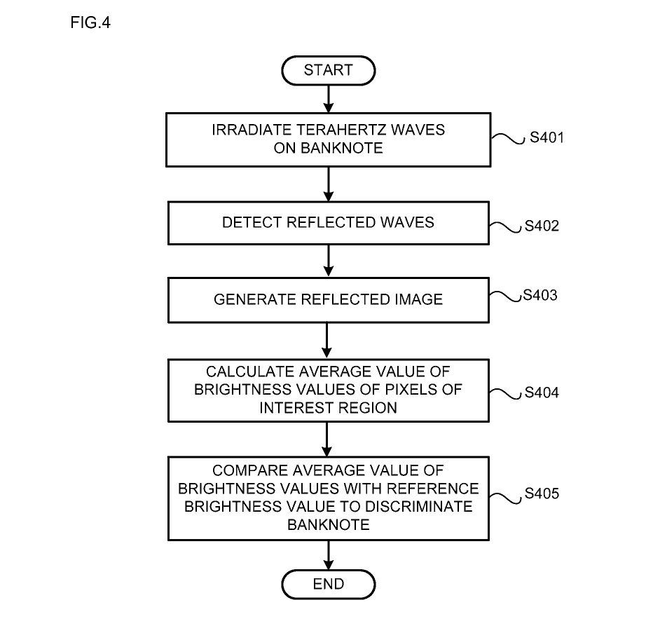

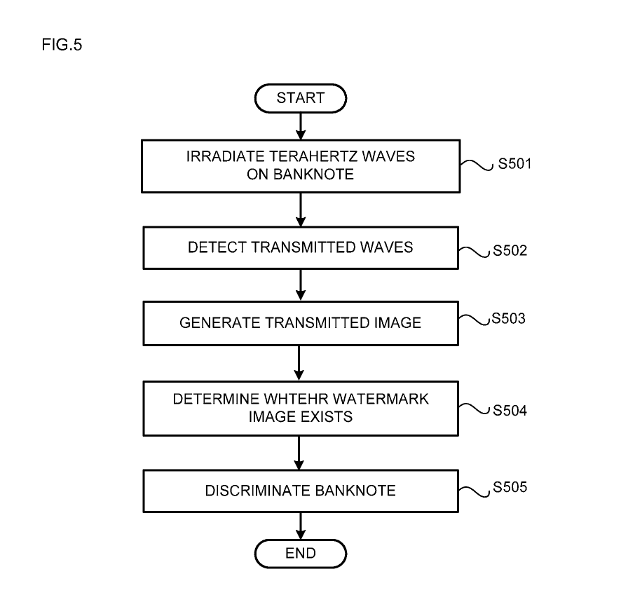

First, the banknote discriminating method using the reflected image of the banknote by the terahertz waves will be described as follows with reference to FIG. 4.

As illustrated in FIG. 4, the controller 40 operates the terahertz wave irradiating unit 10 to irradiate the terahertz waves on the banknote 100 S401. Then, the reflected wave detecting unit 21 detects the reflected waves reflected from the banknote 100 to provide an electrical signal for the detected reflected waves to the controller 40 S402.

Then, the controller 40 generates the reflected image of the banknote based on the electrical signal input from the reflected wave detecting unit 21, that is, the detection signal detected by the reflected wave detecting unit 21 S403.

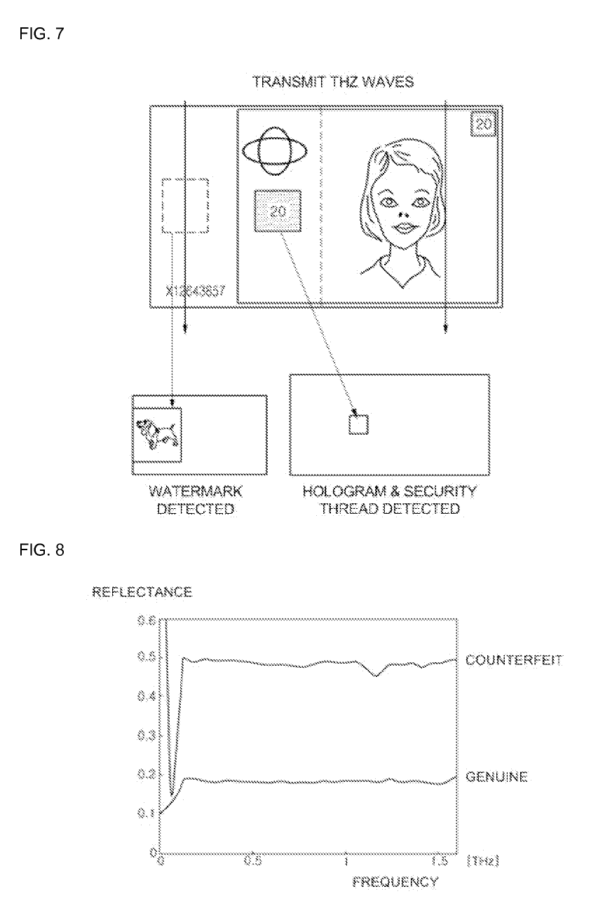

Next, the controller 40 determines whether the banknote is counterfeit or genuine after performing a predetermined image process using the reflected image of the banknote. To be specific, the controller 40 calculates brightness values of respective pixels in a predetermined interest region of the reflected image of the banknote to calculate an average value of the brightness values S404. Here, the interest region means a region in the reflected image corresponding to a region in which a hologram or a security thread in the banknote is positioned and refers to a specific region in the reflected image corresponding to the hologram or the security thread positioned in the banknote in order to discriminate the banknote as illustrated in FIG. 7. Brightness values are large when brightness components are high and small when brightness components are low. For example, relative brightness values may be represented under the assumption that the brightest color (white) has a brightness value of 255 and the darkest color (black) has a brightness value of 0, or under other similar assumptions.

Then, the controller 40 compares the average value of the brightness values of the respective pixels in the interest region with a predetermined reference brightness value to determine whether the banknote is counterfeit or genuine S405. As described above, since the interest region is a region in the reflected image corresponding to the region in which the hologram or the security thread in the banknote is positioned, when the banknote is a genuine banknote, reflectance of the interest region is higher than those of other regions so that, as illustrated in FIG. 7, the brightness values of the pixels in the interest region are larger than brightness values of pixels in other regions. Therefore, when the average value of the brightness values of the pixels in the interest region is larger than a predetermined reference brightness value, the banknote may be determined as a genuine banknote. However, when the average value of the brightness values of the pixels in the interest region is no more than the predetermined reference brightness value, the banknote may be determined as a counterfeit banknote. When it is determined whether the banknote is counterfeit or genuine, the controller 40 may output the determination result through an output unit 60 of FIG. 1.

On the other hand, in the above embodiment, the average value of the brightness values of the respective pixels in the interest region is used. However, the present invention is not limited to the above. An intermediate value of the brightness values may be used, specific several brightness values among the brightness values may be used, or the brightness values by other methods may be used to determine counterfeit banknotes.

According to the present embodiment, since the brightness values may be calculated merely for the interest region and it is determined whether the banknote is counterfeit or genuine in accordance with the calculated result, it is possible to reduce time spent on operations for counterfeit banknote determination and to improve correctness of counterfeit banknote determination.

Banknote Discriminating Method Using Transmitted Image

Next, the method of discriminating the banknote using the transmitted image of the banknote by terahertz waves will be described with reference to FIG. 5.

As illustrated in FIG. 5, the controller 40 operates the terahertz wave irradiating unit 10 to irradiate the terahertz waves on the banknote 100 S501. Then, the transmitted wave detecting unit 23 detects the transmitted waves transmitted through the banknote 100 to provide an electrical signal for the detected transmitted waves to the controller 40 S502.

Then, the controller 40 generates the transmitted image of the banknote based on the electrical signal input from the transmitted wave detecting unit 23, that is, the detection signal detected by the transmitted wave detecting unit 23 S503.

Next, the controller 40 determines whether the banknote is counterfeit or genuine after performing a predetermined image process using the transmitted image of the banknote. To be specific, the controller 40 determines whether a watermark image exists in a predetermined interest region of the transmitted image of the banknote S504. Here, the interest region means a region in the transmitted image corresponding to a region in which the watermark in the banknote is positioned and refers to a specific region in the transmitted image corresponding to the watermark positioned in the banknote in order to discriminate the banknote as illustrated in FIG. 7.

In detecting whether the watermark image exists, the controller 40 may determine whether the watermark image exists by comparing the brightness values of the pixels in the interest region with a predetermined reference value or comparing the interest region with a predetermined master pattern. That is, the controller 40 may compare the average value or an intermediate value of the brightness values of the respective pixels in the interest region, or a brightness value of one or more specified pixels with the predetermined reference value, to determine that the watermark exists when the average value or the intermediate value of the brightness values of the respective pixels in the interest region, or the brightness value of the specified pixel(s), is smaller than the predetermined reference value. Any other method using the brightness values of the respective pixels in the interest region may be applied.

In addition, the controller 40 may determine whether the watermark image exists by comparing the interest region with a previously stored master pattern. The controller 40 may compare the interest region of the transmitted image with the master pattern stored in a memory unit 50 to determine that the watermark exists when the interest region coincides with the master pattern.

Then, the controller 40 determines whether the banknote is counterfeit or genuine based on whether the watermark image exists S505. As described above, since the interest region is a region corresponding to the region in which the watermark is positioned in the banknote, when the banknote is genuine, as illustrated in FIG. 7, it will be determined that the watermark exists in the interest region. Therefore, the banknote may be determined as a genuine banknote when the watermark exists in the interest region. To the contrary, the banknote may be determined as a counterfeit banknote when the watermark does not exist in the interest region. By doing so, when the banknote is determined as a genuine banknote or a counterfeit banknote, the controller 40 may output the determination result through the output unit 60 of FIG. 1.

As described above, according to the present embodiment, since the terahertz waves with high transmit power may be irradiated on the banknote so that the transmitted image of the watermark region of the banknote may be more clearly generated, it may be more easily and correctly determined whether the banknote is counterfeit or genuine. In addition, when a pattern of the interest region is extracted to be compared with a master pattern, operation time spent on determining whether the banknote is counterfeit or genuine may be reduced.

According to another embodiment in which the transmitted image of the banknote by terahertz waves is used, before determining whether the banknote is counterfeit or genuine, comparing the transmitted image of the banknote generated by the controller 40 with a master pattern stored in the memory unit 50 to determine the denomination of the banknote 100 may be performed.

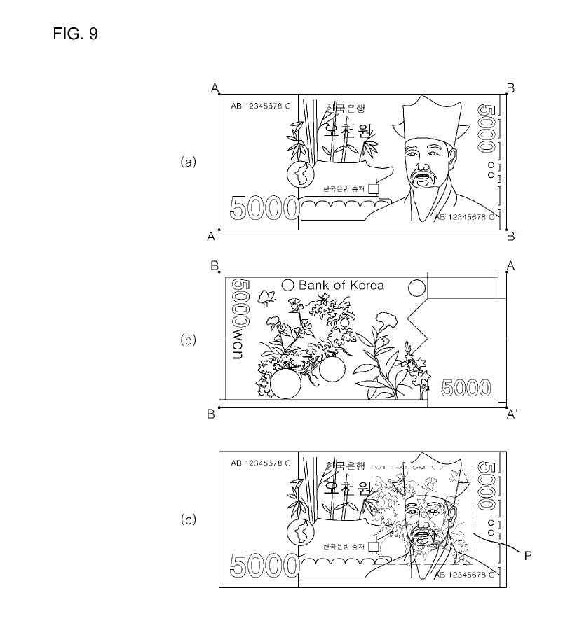

Terahertz waves may have high transmit power, so most terahertz waves are typically transmitted through the banknote 100 and input to the transmitted wave detecting unit 23. As a result, images of the front surface and the rear surface of the banknote 100 may overlap in the transmitted image of the banknote as shown in FIG. 9. In addition, a transmitted image of the banknote with high resolution may be obtained. At this time, the controller 40 extracts a transmitted pattern of the interest region from the transmitted image of the banknote and compares the extracted transmitted pattern with the master pattern stored in the memory unit 50 to determine the denomination of the banknote 100.

On the other hand, the controller 40 may generate the reflected image of the banknote based on the electrical signal input from the reflected wave detecting unit 21 and may determine the denomination of the banknote 100 using both the reflected image and the transmitted image. That is, the controller 40 may combine the reflected image and the transmitted image with each other to generate a combined image, and may extract a combined pattern from the combined image, to compare the combined pattern with a master pattern stored in the memory unit 50 and determine the denomination of the banknote 100.

Similarly, the controller 40 may extract a reflected pattern of the interest region from the reflected image of the banknote, and may compare the extracted reflected pattern with a master pattern stored in the memory unit 50, to determine the denomination of the banknote 100.

The master pattern based on which the denomination of the banknote 100 is determined is stored in the memory unit 50. The master pattern may be variously defined in accordance with a comparison target (for example, the transmitted pattern, the reflected pattern, and the combined pattern) or an interest region. Since it is not possible to determine the denomination of the banknote whose master pattern is not stored, master patterns of as many various denominations of banknotes as possible are preferably stored in the memory unit 50.

The output unit 60 outputs the banknote denomination determination result or an error message determined in the controller 40. Here, the banknote denomination determination result includes information on the denomination of the banknote 100, and the error message means a message output when the denomination of the banknote 100 may not be determined. The output unit 60 may include a display panel (not shown) to display the banknote denomination determination result or the error message on the display panel and may include a speaker (not shown) to output the banknote denomination determination result or the error message as voice.

Referring to FIG. 9, when a 5,000 won banknote in Korea is discriminated, as illustrated in FIG. 9, images of a front surface and a rear surface of the 5,000 won banknote overlap each other in a transmitted image. At this time, as illustrated in FIG. 9, a region that represents characteristics of the 5,000 won banknote may be selected as an interest region P from an entire region of the transmitted image to be extracted as a transmitted pattern.

After extracting the transmitted pattern as described above, the controller 40 compares the transmitted pattern with the master pattern stored in the memory unit 50.

The controller 40 determines whether there is the master pattern that coincides with the transmitted pattern as the result of comparison and controls the output unit 60 to output the banknote denomination determination result when it is determined that there is the master pattern that coincides with the transmitted pattern.

On the other hand, when it is determined that there is no master pattern that coincides with the transmitted pattern, since the denomination of the banknote may not be determined, the controller 40 controls the output unit 60 to output the error message.

At this time, that the transmitted pattern coincides with the master pattern is not limited to the case in which all the pixels of the two patterns are physically completely the same but includes the case in which the pixels of the two patterns are different from each other within an error range.

As described above, in the method of discriminating the denomination of the banknote using the terahertz waves according to the present invention, since the terahertz waves with high transmit power may be irradiated on the banknote to generate the clear transmitted image in which the front surface and the rear surface of the banknote overlap each other, the denomination of the banknote may be easily and correctly determined. In addition, since the pattern of the interest region is extracted to be compared with the master pattern, operation time spent on determining the denomination of the banknote may be reduced.

According to the above-described embodiment, the transmitted pattern is extracted from the transmitted image of the banknote and the transmitted pattern is compared with the master pattern to determine the denomination of the banknote. However, the denomination of the banknote may be determined using both the reflected image and the transmitted image and using only the reflected image.

According to another embodiment of the present invention, the controller 40 operates the terahertz wave irradiating unit 10 to irradiate the terahertz waves onto the banknote 100, and receives electrical signals for the reflected waves and the transmitted waves from the detecting units 21 and 23.

To be specific, the controller 40 receives the electrical signal for the reflected waves reflected from the banknote 100 from the reflected wave detecting unit 21, and receives the electrical signal for the transmitted waves transmitted through the banknote 100 from the transmitted wave detecting unit 23.

The controller 40 generates the reflected image and the transmitted image using the electrical signals input from the detecting units 21 and 23, and extracts the combined pattern of the interest region from the combined image of the reflected image and the transmitted image.

Then, the controller 40 compares the combined pattern with the master pattern stored in the memory unit 50.

The controller 40 determines whether the master pattern coincides with the combined pattern as the result of the comparison, and controls the output unit 60 to output the banknote denomination determination result when it is determined that the master pattern coincides with the combined pattern.

On the other hand, when there is no master pattern that coincides with the combined pattern, since the denomination of the banknote may be not correctly determined, the controller 40 controls the output unit 60 to output the error message.

As described above, when the denomination of the banknote is determined using both the reflected image and the transmitted image, correctness of banknote denomination determination may be improved in comparison with the case in which only the transmitted image is used.

On the other hand, according to the present embodiment, the structures of the terahertz wave irradiating unit 10 and the detecting units 21 and 23 are described as illustrated in FIG. 1. However, the present invention is not limited to the above, but rather, the structures of the terahertz wave irradiating unit 10 and the detecting units 21 and 23 may be modified in various forms where the terahertz waves may be irradiated onto the banknote 100 to detect the reflected image or the transmitted image of the banknote 100.

Banknote Discriminating Method Using Reflected Wave Energy

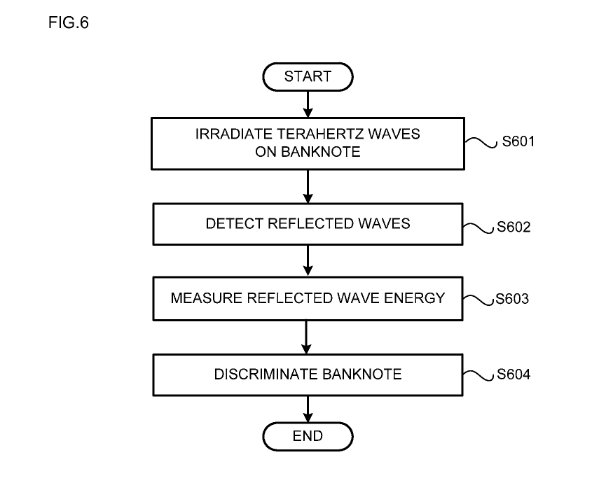

The method of discriminating the banknote using the reflected wave energy of the reflected waves will be described with reference to FIGS. 6 and 8.

As illustrated in FIG. 6, the controller 40 operates the terahertz wave irradiating unit 10 to irradiate the terahertz wave onto the banknote 100 S601. Then, the reflected wave detecting unit 21 detects the reflected waves reflected from the banknote 10 S602.

Then, the reflected wave energy measuring unit 30 measures the reflected wave energy of the reflected waves based on the electrical signal input from the reflected wave detecting unit 21, that is, the detection signal detected by the reflected wave detecting unit 21 S603. Here, the reflected wave energy means energy of the reflected waves reflected from the banknote when the terahertz waves of specified output power are irradiated onto the banknote.

Next, the controller 40 determines whether the banknote is counterfeit or genuine based on the reflected wave energy measured by the reflected wave energy measuring unit 30 S604. The material of the banknote that plays an absolute role on the quality of the banknote and preventing the banknote from being forged contains cotton generally or a mixture of cotton and linen in some countries such as the U.S., the United Kingdom, and France. Therefore, a real banknote has unique characteristics of reflected waves reflected from the banknote that are different from characteristics of common paper when the terahertz waves are irradiated. In particular, the energy of the reflected waves has a lower reflectance than that of common paper as illustrated in FIG. 8.

Therefore, according to the present embodiment, when it is determined whether the banknote is counterfeit or genuine, the controller 40 determines whether the banknote is counterfeit or genuine based on the reflectance (the reflected terahertz waves/the irradiated terahertz waves) of the reflected wave energy with respect to the energy of the terahertz waves irradiated on the banknote. In particular, the controller 40 determines the banknote as a counterfeit banknote when the reflectance is larger than a predetermined reference reflectance (for example, 0.5) and determines the banknote as a genuine banknote when the reflectance is not greater than the reference reflectance. By doing so, when the banknote is determined as a counterfeit banknote or a genuine banknote, the controller 40 may output the determination result through the output unit 60 of FIG. 1.

According to the present embodiment, it is possible to simply and correctly determine whether the banknote is counterfeit or genuine by measuring the energy of the terahertz waves irradiated onto the banknote and the energy of the reflected waves reflected from the banknote.

As described above, the banknote discriminating apparatus using terahertz waves according to the present embodiment may irradiate the terahertz waves onto the banknote to determine whether the banknote is counterfeit or genuine, or determine the denomination of the banknote, using at least one of i) the reflected image of the banknote generated by the reflected waves reflected from the banknote, ii) the transmitted image generated by the transmitted waves transmitted through the banknote, and iii) the reflected wave energy of the reflected waves reflected from the banknote. That is, the banknote discriminating apparatus using terahertz waves according to the present embodiment may discriminate the banknote by one of the reflected image of the banknote, the transmitted image of the banknote, and the reflected wave energy of the reflected waves or a combination of the reflected image of the banknote, the transmitted image of the banknote, and the reflected wave energy of the reflected waves.

Therefore, the banknote discriminating apparatus using terahertz waves according to the present embodiment may discriminate the banknote using not only each of the reflected image of the banknote and the transmitted image of the banknote, but also the reflected image of the banknote and the reflected wave energy of the reflected waves, and may discriminate the banknote using all of the reflected image of the banknote, the transmitted image of the banknote, and the reflected wave energy of the reflected waves. When the banknote is discriminated using at least two of the i) the reflected image of the banknote, ii) the transmitted image of the banknote, and iii) the reflected wave energy of the reflected waves, since the discrimination results in accordance with the respective methods may be different from each other, at this time, the final determination may be made by providing weighted values or orders of priority to the discrimination results in accordance with the respective methods. For example, when all three of the above methods are used, the final determination may be made i) by providing the order or priority in the order of the determination result using the reflected image of the banknote>the determination result using the reflected wave energy of the reflected waves>the determination result using the transmitted image of the banknote, ii) in accordance with at least two methods with the same determination result among the three methods, or iii) by providing weighted values in the order of reliable methods among the three methods.

As described above, according to the present invention, it is possible to easily and correctly determine whether the banknote is counterfeit or genuine or the denomination of the banknote using the reflected waves or the transmitted waves generated by irradiating the terahertz waves.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of discriminating a banknote, comprising:
irradiating the banknote with terahertz waves;
detecting reflected waves reflected from the banknote;
generating a reflected image of the banknote based on the detected reflected waves; and
discriminating the banknote based on the reflected image.

2. The method of claim 1, wherein discriminating the banknote based on the reflected image includes determining whether the banknote is counterfeit or genuine.

3. The method of claim 1, wherein discriminating the banknote based on the reflected image includes determining a denomination of the banknote.

4. The method of claim 1, wherein discriminating the banknote based on the reflected image comprises calculating brightness values of respective pixels in a predetermined interest region of the reflected image, discriminating the banknote based on the calculated brightness values.

5. The method of claim 4, wherein discriminating the banknote comprises comparing an average value of the brightness values of the respective pixels in the interest region with a reference brightness value.

6. The method of claim 4, wherein the interest region is a region in the reflected image corresponding to a region of the banknote containing a hologram or a security thread.

7. The method of claim 4, wherein the banknote is discriminated based on an intermediate value of the brightness values or a specific subset of brightness values among the calculated brightness values.

8. A method of discriminating a banknote. comprising:
irradiating the banknote with terahertz waves;
detecting transmitted waves transmitted through the banknote;
generating a transmitted image of the banknote based on the detected transmitted waves; and
discriminating the banknote based on the transmitted image.

9. The method of claim 8, wherein discriminating the banknote based on the transmitted image includes determining whether the banknote is counterfeit or genuine.

10. The method of claim 8, wherein discriminating the banknote based on the transmitted image includes determining a denomination of the banknote.

11. The method of claim 8, wherein discriminating the banknote based on the transmitted image comprises determining whether a watermark image exists in a predetermined interest region of the transmitted image.

12. The method of claim 11, wherein the interest region is a region in the transmitted image corresponding to a region of the banknote containing the watermark.

13. The method of claim 11, wherein determining whether the watermark image exists in the predetermined interest region of the transmitted image comprises comparing brightness values of pixels in the interest region with a predetermined reference value, or comparing the interest region with a predetermined master pattern.

14. The method of claim 8, further comprising:
detecting reflected waves reflected from the banknote;
generating a reflected image of the banknote based on the detected reflected waves; and
discriminating the banknote based on the transmitted image and the reflected image.

15. The method of claim 14, wherein discriminating the banknote based on the transmitted image and the reflected image includes determining whether the banknote is counterfeit or genuine.

16. The method of claim 14, wherein discriminating the banknote based on the transmitted image and the reflected image includes determining a denomination of the banknote.

17. The method of claim 14, wherein discriminating the banknote based on the transmitted image and the reflected image comprises comparing an average brightness value of respective pixels in a predetermined first interest region of the reflected image with a predetermined reference brightness value, and determining whether a watermark image exists in a predetermined second interest region of the transmitted image.

18. A method of discriminating a banknote, comprising:
irradiating the banknote with terahertz waves;
detecting reflected waves reflected from the banknote;
measuring an energy of the reflected waves; and
discriminating the banknote based on the measured energy.

19. The method of claim 18, wherein discriminating the banknote is based on the measured energy of the reflected wave energy and an energy of the terahertz waves with which the banknote is irradiated.

20. The method of claim 19, wherein the banknote is determined to be a counterfeit banknote when the reflectance is larger than a predetermined reference reflectance.
